(19) United States
(12) Patent Application Publication
(10) Pub. No.: US 2006/0038089 A1
(43) Pub. Date: Feb. 23, 2006

(54) Hang glider wheel apparatus

(76) Inventor: Brad D. Kushner, Delavan, WI (US)

Correspondence Address: QUINN LAW GROUP PLLC, SUITE 520, 39555 ORCHARD HILL PLACE, NOVI, MI, 48375, US

(21) Appl. No.: 11/139,898

(22) Filed: May 27, 2005

Related U.S. Application Data
(60) Provisional application No. 60/574,862, filed on May 27, 2004.

(51) Int. Cl. B64D 17/34; B64C 13/04

(52) U.S. Cl. 244/220; 244/152; 244/904

(57) ABSTRACT

A hub includes an inner surface that defines a noncircular, and preferably airfoil-shaped, aperture. The aperture is sufficiently sized and shaped for the inner surface to circumscribe a member having a noncircular cross section for retaining the hub to the member. A wheel is rotatable around the periphery of the hub. The hub thus functions as an adapter to enable a wheel to rotate about the noncircular member.

### CROSS REFERENCE TO RELATED APPLICATION

This application claims the benefit of U.S. Provisional Application No. 60/574,862, filed May 27, 2004, and which is hereby incorporated by reference in its entirety.

### TECHNICAL FIELD

This invention relates to hang glider wheels that include a hub with a noncircular aperture for attachment to a member having a noncircular cross section.

### BACKGROUND OF THE INVENTION

Hang gliders typically include a basetube. The basetube is typically the lowest horizontal bar on a hang glider. The basetube is typically part of a “control bar” that extends downward from a hang glider wing. In flight, the basetube is the preferred place for the hands of the pilot who is controlling the hang glider.

The prior art includes cylindrical basetubes, i.e., tubular structures with a circular cross-section. Cylindrical basetubes are typically straight, although “speedbar”-style basetubes have become common, where the basetube is bent in gentle curves (usually fore and aft) to allow the hands and wrists a more comfortable, ergonomic grasp. The curves of a “speedbar” basetube are not unlike the curves of a “curling bar” in weight lifting, which similarly improve the alignment of the hands and wrists when using the bar for leverage.

A cylindrical basetube may be equipped with wheels. The wheels allow the hang glider to roll instead of lurching to a stop when the glider is dropped to the ground by a pilot during landing. The wheels also allow the glider to be rolled from one place to another without the need to lift and carry it.

Basetubes that are airfoil shaped, instead of circular in cross section, improve hang glider performance compared to cylindrical basetubes.

### SUMMARY OF THE INVENTION

An apparatus for a hang glider control bar basetube having a noncircular cross sectional shape is provided. The apparatus includes a wheel hub having an inner surface that defines a noncircular aperture sufficiently sized and shaped to circumscribe the basetube for nonrotatably mounting the hub to the basetube. A wheel is rotatable about the periphery of the hub so that the basetube functions as an axle for the wheel. The hub thus functions as an adapter to enable a wheel to rotate about a member having a noncircular cross section. In a preferred embodiment, the noncircular aperture is substantially airfoil-shaped to conform to the exterior surface of a basetube having an airfoil-shaped cross section.

In a preferred embodiment, the hub has a selectively variable opening extending from the periphery of the hub to the aperture to facilitate installation of the hub to the basetube.

The above features and advantages, and other features and advantages, of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a hang glider;

FIG. 2 is a schematic perspective view of the basetube of the hang glider of FIG. 1 with a hub and wheel operatively connected thereto;

FIG. 3 is a schematic side view of the hub of FIG. 2;

FIG. 3a is a schematic side view of another hub for use with the basetube of FIG. 2;

FIG. 4 is a schematic perspective view of an unassembled wheel;

FIG. 5 is a schematic perspective view of the hub of FIG. 3a with a wheel subcomponent engaged therewith;

FIG. 6 is another schematic perspective view of the hub and wheel subcomponent of FIG. 5; and

FIG. 7 is a schematic perspective view of an alternative wheel hub configuration.

### DESCRIPTION OF THE PREFERRED EMBODIMENTS

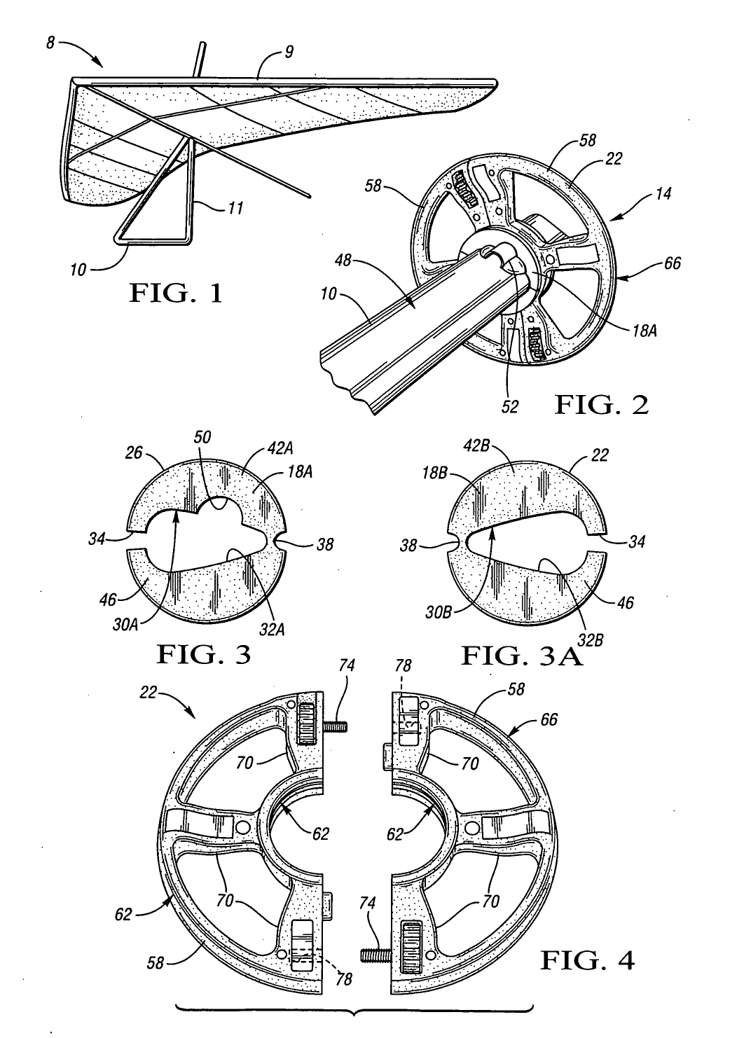

Referring to FIG. 1, a hang glider 8 is schematically depicted. Exemplary hang glider construction is disclosed in U.S. Pat. No. 3,995,799, issued Dec. 7, 1976 to Bartolini, and U.S. Pat. No. 4,116,407, issued Sep. 26, 1978 to Murray, each of which is hereby incorporated by reference in its entirety. The hang glider 8 includes a wing 9 and a triangular control bar 11 that extends downward from the wing 9. A basetube 10 forms the generally horizontal base of the control bar 11. Although a triangular control bar is depicted in FIG. 1, a control bar of any shape may be employed within the scope of the claimed invention. The basetube 10 is characterized by an airfoil cross-sectional shape. The basetube 10 may be integrally formed with the control bar 11, may be connected to the rest of the control bar 11 via releasable fasteners, etc.

Referring to FIG. 2, wherein like reference numbers refer to like components from FIG. 1, a wheel apparatus 14 includes a hub 18A and a wheel 22. The hub 18A is nonrotatably mounted to the basetube 10. The hub 18A rotatably supports and retains the wheel 22 at the periphery of the hub 18A. The basetube 10 functions as an axle for the wheel apparatus 14, and is at least partially coextensive with the axis of rotation of the wheel 22. The hub 18A includes a generally circular periphery 26, as shown in FIG. 3. An inner surface 30A defines a generally airfoil-shaped interior aperture 32A that substantially conforms to the exterior contour of the basetube 10. The hub 18A has a variable opening 34 extending from the inner surface 30A to the periphery 26 to receive the basetube 10 into the aperture 32A, as shown in FIG. 2. The hub 18A includes a living hinge 38 about which a first portion 42A of the hub 18A is pivotable with respect to a second portion 46 of the hub 18A to selectively increase or decrease the size of the opening 34. The aperture 32A is sufficiently sized and shaped such that, when the basetube is received in the aperture 32A and the portions 42A, 46 are pivoted about the living hinge 38 to close the opening 34, the inner surface 30A circumscribes the basetube so that the hub 18A is circumjacent the basetube. At least a portion of the inner surface 30A of the aperture 32A contacts at least a portion of the exterior surface (depicted at 48 in FIG. 2) of the basetube 10 to nonrotatably retain the hub 18A on the basetube 10.

The generally airfoil-shaped aperture 32A of hub 18A includes a semicircular portion 50 to allow unimpeded passage of cables, strings, and other control devices from one side of the wheel hub to the other. In the embodiment depicted, a variable geometry (VG) string (not shown) is routable through portion 50. Referring to FIGS. 2 and 3, the basetube 10 in the embodiment depicted includes a guide 52 mounted thereon that retains and guides the VG string. Guide 52 at least partially extends through portion 50 when the hub 18A is mounted to the basetube 10. Referring to FIG. 3a, wherein like reference numbers refer to like components from FIGS. 2 and 3, hub 18B is substantially identical to hub 18A, except that hub 18B does not have portion 50 for a VG string and VG string guide. The shape of aperture 32B is substantially identical to the cross-sectional shape of the basetube. Hub 18B is configured to be mounted to the basetube 10 a distance apart from hub 18A.

In an alternative embodiment, and within the scope of the claimed invention, the opening 34 and the living hinge 38 can be eliminated, such that the hub is circumferentially continuous. In such an embodiment, the hub 18B may be installed by inserting the end of the basetube into the aperture 32B prior to the basetube being attached to the rest of the control bar and hang glider. The opening 34 and the living hinge 38 allow the hub to be installed to the basetube after the hang glider is completely assembled.

In another alternative embodiment, and within the scope of the claimed invention, the hub 18B comprises two or more separable sub-components that join to form the interior aperture and circular periphery.

The hub 18B may include asymmetrical channels and additional holes, grooves, apertures, etc., within the scope of the claimed invention. The purpose and function of these additional features would include, but not be limited to, the ability of the hub to fit over or around structures added to the airfoil basetube, such as cleats or other hardware.

Referring to FIG. 4, wherein like reference numbers refer to like components from FIGS. 1-3a, the wheel 22 comprises two subcomponents 58, each including a semicircular or semiannular inner surface 62 and a semicircular or semiannular outer surface 66 interconnected by spokes 70. Each subcomponent 58 includes fastening components, namely a threaded fastener 74 and a threaded hole 78. The threaded fastener 74 of each subcomponent is engageable with the threaded hole 78 on the other subcomponent to operatively connect the subcomponents to one another and thereby form the wheel 22.

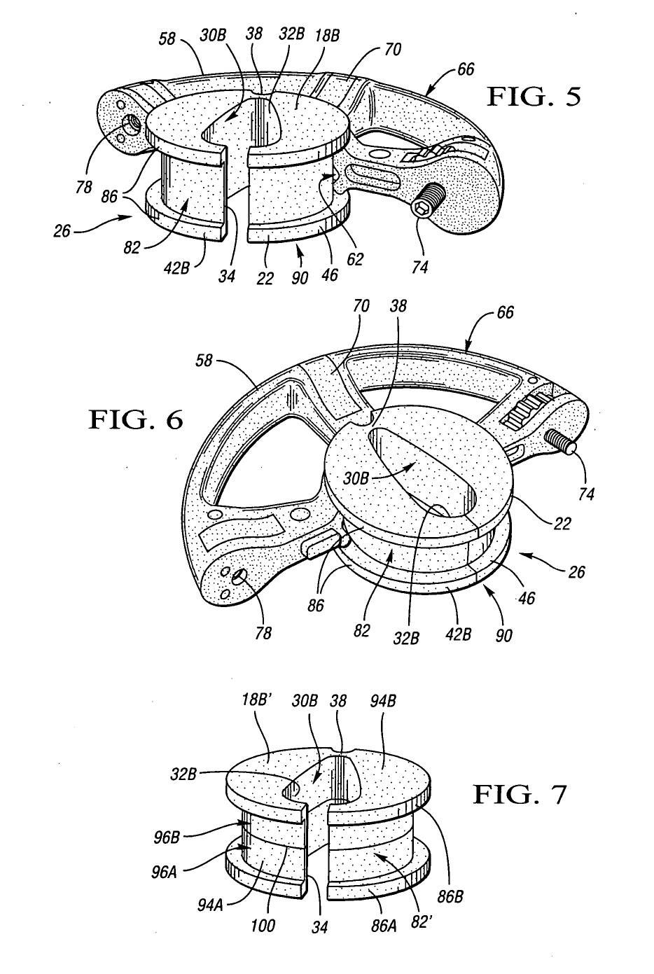

Referring to FIGS. 5 and 6, wherein like reference numbers refer to like components from FIGS. 1-4, the periphery 26 of the hub 18B is characterized by an annular outer surface 82, also referred to herein as a “bearing surface,” between two flanges 86 extending radially outward from bearing surface 82 to form a track 90. The wheel is connected to the hub 18B by connecting the two subcomponents 58 to one another via the fastening elements 74, 78 so that the inner surfaces 62 of the subcomponents 58 cooperate to form a circular or annular surface that engages, or contacts, the annular outer surface 82. The wheel subcomponents 58, when connected to one another, compress the hub 18B to close the opening 34, as depicted in FIG. 6. Alternatively, and within the scope of the claimed invention, other means may be employed to close the opening 34. For example, the hub could be compressed manually, and fasteners may be employed so that opening 34 remains closed prior to installation of the wheel. In the embodiment depicted, the bearing surface 82 rotatably supports the wheel by directly contacting inner surfaces 62 such that inner surfaces 62 are slidable with respect to the bearing surface 82. However, and within the scope of the claimed invention, the hub 18B and bearing surface 82 may rotatably support the wheel indirectly, with friction-reducing components, such as rollers, positioned interjacent the bearing surface 82 and the inner surfaces 62.

Flanges 86 restrict axial movement of the wheel by physical part interference to retain the wheel 22 to the hub 18B. Those skilled in the art will recognize a variety of other means to restrict axial movement of the wheel 22 with respect to the hub 18B that may be employed within the scope of the claimed invention. For example, the hub 18B may include one or more flanges at the periphery, and the wheel 22 may include one or more grooves in which the one or more flanges is inserted in a tongue-and-groove style configuration.

Those skilled in the art will recognize a variety of materials that may be employed to form the hub. In a preferred embodiment, the hub comprises a polymeric material such as nylon. It should be noted that, although the hubs depicted in the figures are one-piece, a hub may be an assembly of different components within the scope of the claimed invention.

Referring to FIG. 7, wherein like reference numbers refer to like components from FIGS. 1-6, an alternative hub 18B′ is depicted. The hub 18B′ includes a first subcomponent 94A that includes a surface 96A that forms approximately one half of bearing surface 82′. The first subcomponent 94A also includes one flange 86A. The hub 18B′ includes a second subcomponent 94B that includes a surface 96B that forms the remainder of the bearing surface 82′. The second subcomponent 94B also includes a flange 86B. The subcomponents 94A, 94B are separable at split line 100, enabling a unitary, one piece wheel (not shown) to be mounted to the hub 18B′. Thus, a user may install only the first subcomponent 94A to the basetube. Surface 96A has a flange 86A on only one side, and is accessible for mounting a one-piece wheel on the other side. The one-piece wheel is mountable to the first subcomponent 94A via the end of the basetube prior to installation of the basetube to the control bar. After mounting the one-piece wheel to the first subcomponent 94A such that the inner surface of the wheel engages surface 96A, the second subcomponent 94B may be installed on the basetube such that the one-piece wheel engages surface 96B. The subcomponents are then fastened together, such as by mechanical fasteners (not shown). Flange 86A and flange 86B then restrict axial movement of the one-piece wheel with respect to the hub 18B′.

Alternatively, and within the scope of the claimed invention, the embodiment of FIG. 7 may be characterized by the absence of a living hinge and variable opening so that surfaces 96A and 96B are circumferentially continuous, resulting in a circumferentially continuous outer surface 82′. In such an embodiment, the hub 18B′ is connected to a basetube by inserting the end of the basetube through the aperture 32B.

Other means of connecting the wheel to the hub may be employed within the scope of the claimed invention. For example, a wheel may be permanently, rotatably connected to the hub to form an assembly, and the hub may be connected to the basetube by inserting the end of the basetube through the noncircular aperture.

Various features shown and described in accordance with the different embodiments of the invention illustrated may be combined.

While the best modes for carrying out the invention have been described in detail, those familiar with the art to which this invention relates will recognize various alternative designs and embodiments for practicing the invention within the scope of the appended claims.

1. An apparatus for a hang glider having a control bar basetube with a non-circular cross section, the apparatus comprising:
a wheel hub having an inner surface that defines a noncircular aperture sufficiently sized and shaped for the inner surface to circumscribe the non-circular basetube to nonrotatably mount the hub to the basetube.

2. The apparatus of claim 1, wherein the wheel hub is characterized by a selectively variable opening between the hub periphery and the noncircular aperture.

3. The apparatus of claim 2, wherein the wheel hub includes a living hinge about which a first portion of the hub is pivotable with respect to a second portion of the hub to selectively open and close the variable opening.

4. The apparatus of claim 1, further comprising a wheel rotatably mounted to the wheel hub.

5. The apparatus of claim 1, wherein the wheel hub defines a track configured to rotatably support a wheel with respect to the wheel hub.

6. The apparatus of claim 5, wherein the track includes at least one flange extending radially with respect to the wheel hub and structurally configured to restrict axial movement of the wheel.

7. The apparatus of claim 1, wherein the wheel hub includes a first portion defining a first annular flange and a second portion defining a second annular flange; wherein the first and second portions are selectively separable; and wherein the first and second portions are selectively connectable on the base tube such that the first flange and the second flange are spaced a distance apart from one another to form an annular groove therebetween at the periphery of the hub.

8. The apparatus of claim 1, wherein the noncircular aperture is generally airfoil shaped.

9. A hang glider comprising:
a wing; a control bar situated below the wing and including a generally horizontal basetube with a non-circular cross-section; and a wheel hub defining a noncircular aperture through which at least a portion of the basetube extends such that the wheel hub is nonrotatably mounted with respect to the basetube.

10. The hang glider of claim 9, wherein the wheel hub is characterized by a selectively variable opening between the hub periphery and the noncircular aperture.

11. The hang glider of claim 10, wherein the wheel hub includes a living hinge about which a first portion of the hub is pivotable with respect to a second portion of the hub to selectively open and close the variable opening.

12. The hang glider of claim 9, further comprising a wheel rotatably mounted to the wheel hub.

13. The hang glider of claim 9, wherein the wheel hub defines a track configured to rotatably support a wheel with respect to the wheel hub.

14. The hang glider of claim 13, wherein the track includes at least one flange extending radially with respect to the wheel hub and structurally configured to restrict axial movement of the wheel.

15. The hang glider of claim 9, wherein the wheel hub includes a first portion defining a first annular flange and a second portion defining a second annular flange; wherein the first and second portions are selectively separable; and wherein the first and second portions are selectively connectable on the base tube such that the first flange and the second flange are spaced a distance apart from one another to form an annular groove therebetween at the periphery of the hub.

16. The hang glider of claim 9, wherein the basetube is at least partially airfoil shaped.

17. An apparatus for a hang glider having a control bar basetube with a non-circular cross section, the apparatus comprising:
a wheel hub having an inner surface that defines a noncircular aperture sufficiently sized and shaped for the inner surface to circumscribe the non-circular basetube to nonrotatably mount the hub to the basetube;
wherein the wheel hub is characterized by a selectively variable opening between the hub periphery and the noncircular aperture;
wherein the wheel hub defines a track configured to rotatably support a wheel with respect to the wheel hub; and
wherein the track includes at least one flange extending radially with respect to the wheel hub and structurally configured to restrict axial movement of the wheel.
